(19) United States
(12) Patent Application Publication
(10) Pub. No.: US 2026/0356194 A1
(43) Pub. Date: Nov. 12, 2026

(54) IN-VEHICLE SYSTEM

(71) Applicant: HARMAN INTERNATIONAL INDUSTRIES, INCORPORATED, Stamford, CT (US)

(72) Inventors: Jan GEISLER, Munich (DE); Kim Fiskbæk ANDREASEN, Vildbjerg (DK); Marcel PILGAARD HAVEMANN, Hjerm (DK)

(73) Assignee: HARMAN INTERNATIONAL INDUSTRIES, INCORPORATED, Stamford, CT (US)

(21) Appl. No.: 19/124,064

(22) PCT Filed: Nov. 16, 2023
(86) PCT No.: PCT/US2023/080005

§ 371 Date: Apr. 24, 2025

(30) Foreign Application Priority Data
Nov. 16, 2022 (EP) 22207929.5

(51) Int. Cl. B60K 35/22; B60K 35/26; G06F 3/0484; G06F 3/16; H04R 3/12; H05B 47/17; H05B 47/175

(52) U.S. Cl. CPC B60K 35/22; B60K 35/26; G06F 3/0484; G06F 3/165; H04R 3/12; H05B 47/17; H05B 47/1985; B60K 2360/332; B60K 2360/55; H04R 2499/13

(57) ABSTRACT

According to an aspect of the present disclosure, there is provided an in-vehicle system including: one or more loudspeakers; one or more illumination devices associated with the loudspeakers; and a controller to control the illumination devices and/or the loudspeakers, wherein the illumination devices and/or the loudspeakers are controllable to provide a set of functions, wherein the controller is operable in at least first and second mode of operations, wherein in the first mode of operation, the controller is configured to control the illumination devices and/or the loudspeakers to provide only a subset of said functions, and wherein in the second mode of operation, the controller is configured to control the illumination devices and/or the loudspeakers to provide the full set of said functions.

### CROSS-REFERENCE TO RELATED APPLICATIONS

This application is the U.S. national phase of PCT Application No. PCT/US2023/080005 filed on Nov. 16, 2023, which claims priority to EP Application No. 22207929.5 filed on Nov. 16, 2022, the disclosures of which are hereby incorporated in their entirety by reference herein.

### TECHNICAL FIELD

The present invention generally relates to an in-vehicle system, and particularly to an in-vehicle system for providing different on-demand functionalities.

### BACKGROUND OF THE INVENTION

In the information age, digital technology is integrated into many aspects of life. For example, mini-computers, digital displays and touchscreen tablets are readily accessible to people going about their daily lives, whether in their homes and offices, or while on the move. In automotive vehicles, so-called “infotainment” systems are becoming ever more common and popular, offering modern electronic amenities for the convenience and enjoyment of both drivers and passengers. Such a system may include, for example, an audio system with loudspeakers arranged at different locations in the vehicle, and interactive display devices mounted on or near the dashboard to enable the driver to operate the audio system and other elements of the infotainment system.

It is increasingly the expectation that a purchaser of a vehicle can choose from a wide variety of possible configurations for the infotainment system. This represents a challenge during manufacture, because every different configuration may require the manufacturing process to be adjusted.

Accordingly, it is desirable to provide solutions for reconciling the customer's desire to be able to choose from a variety of options and the manufacturers desire to simplify the manufacturing process.

### SUMMARY OF THE INVENTION

The present disclosure provides a system that enables different configurations for in-vehicle devices such as an audio system, loudspeakers and ambient light sources. A selected one of the different configurations can be implemented on demand by the purchaser or user of the vehicle. The other configurations are disabled or inhibited. Thus, the manufacturer of the vehicle is enabled to produce a single system capable of implementing different user choices, thereby simplifying the manufacturing process, without restricting the user's choice.

To achieve these and other objects, there is provided an in-vehicle system including: one or more loudspeakers; one or more illumination devices associated with the loudspeakers; and a controller to control the illumination devices and/or the loudspeakers, wherein the illumination devices and/or the loudspeakers are controllable to provide a set of functions, wherein the controller is operable in at least first and second mode of operations, wherein in the first mode of operation, the controller is configured to control the illumination devices and/or the loudspeakers to provide only a subset of said functions, and wherein in the second mode of operation, the controller is configured to control the illumination devices and/or the loudspeakers to provide the full set of said functions.

The in-vehicle system enables providing different functionalities to a user, depending on a mode of operation. The first mode of operation may correspond to a default mode of operation, in which standard functions are made available to the user. These functions may include an in-vehicle illumination using only a subset of a plurality of illumination devices integrated in the vehicle, and/or an audio playback using only a subset of a plurality of loudspeakers integrated in the vehicle. In other words, in the first mode of operation, some of the functions that the system is capable of providing are locked. In the second mode of operation, these functions are unlocked. Accordingly, in the second mode of operation, the user may enjoy an enhanced set of functions and user experience.

The enhanced set of functions may be unlocked by subscription or purchase. To enable this on a technical level, the controller may be configured to switch from the first mode of operation to the second mode of operation in response to receiving a control signal from a remote server. The control signal may be generated and transmitted by the remote server in response to receiving a user request for a subscription or purchase of the enhanced functions. Such user request may be generated while the system is in use. Accordingly, in an embodiment, the system includes a user interface to enable a user to input a command to cause the remote server to generate and transmit said control signal. The user input corresponds to a transaction to subscribe to or purchase the enhanced functionality.

In the present disclosure, the one or more illumination devices may also be referred to as light source. The modes of operation of the controller may also be referred to as configurations of the system. The present disclosure is not limited to two modes of operation or configurations. There may be any number of modes, each corresponding to a different configuration and set of unlocked functions. However, the vehicle may be equipped to perform all of the available functions from the outset. Whether or not the controller is configured to actually provide all of those functions may depend on the type and scope of subscription or purchases.

In an embodiment, the system is configured to display visual information in the vehicle, wherein the controller is configured to control the light source to display at least first and second visual information in or through a surface in the vehicle; wherein, when the system is in a first configuration (first mode of operation), the controller is operable to display the first visual information only, and, when the system is in a second configuration (second mode of operation), the controller is operable to display the second visual information.

Thus, the system is technically capable of implementing at least two different configurations for the displaying of visual information. However, in the first configuration of the system, the controller is enabled only to display the first visual information. In the first configuration, the controller cannot be operated to display the second information. In other words, in the first configuration, some of the technical capabilities are inhibited. In the second configuration, this inhibition is removed. In other words, the displaying of the second information is unlocked. Accordingly, the system is operable in at least two different modes, each mode corresponding to a configuration selectable by a user (purchaser).

For example, the first visual information may be the logo of an audio system, e.g., the name “SOUND SYSTEM”. The second visual information may be the logo of an enhanced audio system, e.g., “SOUND SYSTEM PLUS”. If the first configuration is enabled, the system displays “SOUND SYSTEM”, e.g., in the dashboard of the vehicle. If the second configuration is enabled, the system displays “SOUND SYSTEM PLUS” instead.

The selection of the first or second configuration may be by way of purchase or subscription. Depending on the selected subscription model or payment, the logos will be updated. For example, a basic subscription means that the first visual information will be displayed (“SOUND SYSTEM”). In an enhanced subscription, the second visual information will be displayed (“SOUND SYSTEM PLUS”). However, the present disclosure is not limited to upgrading or expanding logos. The second visual information can include additional illumination, e.g., mood lighting, or other visual effects or enhancements.

The updating of the displayed visual information can be accompanied by an upgrade of an associated audio system, as described below. Also, in the same way as a service or capability can be unlocked through subscription, the service or capability can be locked again and made unavailable when the subscription expires.

In an embodiment, the system is configured to receive a control signal, and to switch from the first configuration to the second configuration in response to receipt of the control signal. In particular, the system may be configured to receive the control signal from an external source, for example by wireless communication. Thus, it is possible to change the system's configuration remotely. For example, a user may have selected a basic level of capabilities (corresponding to the first configuration) when purchasing the vehicle. During use of the vehicle, she/he may develop a desire to use enhanced capabilities. The user may then purchase an upgrade. Following completion of the purchase, the manufacturer of the vehicle can cause the control signal to be generated and transmitted to the vehicle. In response to receipt of the control signal, the system is upgraded from the first (basic) to the second (enhanced) configuration, thereby enabling the display of the second visual information (e.g. “SOUND SYSTEM PLUS”) and providing enhanced audio playback or other enhanced services.

In an embodiment, the system is included in or coupled to an in-vehicle infotainment system, in particular an in-vehicle audio system, and/or an in-vehicle illumination system. In this embodiment, the first and second configurations can include different capabilities of the infotainment system. As mentioned above, the second configuration may be associated with enhanced audio playback capabilities, for example the ability to play back 3D sound. In this embodiment, the vehicle may always include the necessary hard-and software to implement enhanced audio playback, but the full capability is only used (unlocked) in the second configuration. The same applies to enhanced illumination effects in the second configuration. In an embodiment, the system is included in or coupled to an in-vehicle audio system, wherein, in response to receipt of the control signal, the system is configured to alter one or more parameters and/or the configuration of the audio system. Accordingly, the configuration of the audio system can be remotely adjusted (e.g., enhanced) in response to a new subscription or purchase by the user.

In an embodiment, the system is included in or coupled with a user interface, UI, wherein, in response to receipt of the control signal, the system is configured to alter one or more parameters and/or the configuration of the user interface. In the first configuration, the UI can provide a basic set of options. For example, if the UI is provided to operate the audio system, it can provide options to select audio sources and adjust the volume and sound. If the user purchases or subscribes to the second (enhanced) configuration, additional options may become available, e.g., an option to select 3D sound.

In an embodiment, the controller is configured to display the first or second information at least temporarily in response to activating the system. For example, the controller can control the light source to display a logo on a dashboard of the vehicle. The logo can be displayed throughout operation of the system, or it can be displayed during a bootup phase only.

In an embodiment, the first visual information is included in the second visual information. In addition, or alternatively, the second visual information represents an altered or expanded version of the first visual information. For example, if the visual information is a logo, a first logo can be displayed to indicate that a basic service is selected and active (“SOUND SYSTEM”), whereas a second logo can be displayed to indicate that an enhanced service is selected and active (“SOUND SYSTEM PLUS”).

In an embodiment, the light source comprises a light emitting diode, LED, or an array of LEDs. The system may further comprise a first processor for processing, storing and/or generating visual data, and mapping processor for mapping the visual data to input signals which cause the light source to generate the first or second visual information. Accordingly, the system is capable of displaying more complex information or patterns, and to generate visual effects, particularly in the second configuration.

In an embodiment, the system further comprises a component for the vehicle, the component being configured to be integrated in a dashboard, loudspeaker, pillar, roof, door, seat, ceiling or floor of the vehicle, wherein the light source and the surface are incorporated into the component. Accordingly, the system is suitable for integration into the interior surfaces of a vehicle such as a car. The system allows visual information to be displayed inside a vehicle through any surface to which the system is integrated. This enables various technical capabilities to be implemented, by allowing large portions of the spaces inside a vehicle, from the roof to the pillars and doors, wherever integration is technically feasible, to be utilized as one or more “inconspicuous” display devices. Such display devices may be used for supplying visual information, but also for lighting in an unorthodox manner, thus enhancing the overall user experience of the vehicle, particularly in the second (enhanced) configuration. In other words, as the light source, controller and any other electronic components of the system are hidden by an outer surface seamlessly incorporated into the vehicle, it is possible to provide multiple mechanical devices for displaying information and smart illumination that are only visible when they are needed, but invisible or inconspicuous when deactivated or disabled in the first configuration. This enables a clean and modern appearance that conceals unnecessary elements and reduces distractions for the drivers and passengers. Furthermore, as the display capabilities of the surfaces are not immediately obvious to the unsuspecting passenger, it can lead to an element of pleasant surprise. The messages that are displayed, from logos to titles being played by an audio system, can have an enlarged impact. The type, scope and content of the displayed information depends on the selected configuration, based on the user's purchase or subscription.

In an embodiment, the surface comprises a flexible material, a fabric material, a porous material, an acrylic material, and/or a wooden material. Thus, the surface may be suitable for the display of information by projection of light onto the surface. In addition, or alternatively, the surface comprises a pattern, in particular a pattern formed by holes in the surface. Thus, the surface may be suitable for the display of information by using through-material illumination. Displaying visual information by through-material illumination will not require high-resolution display screens, allowing a more efficient and unobtrusive in-vehicle display and lighting arrangement without reflective or high-glare surfaces, designed using traditional materials, as a mechanism for both providing information and ambient lighting, often at the same time, that is appropriate in an automotive context. Also, sophisticated ambient lighting can be accomplished, in combination with additional capabilities involving reacting to functional sections of the vehicle, such as adapting to audio being played back. Some or all of such enhanced services and capabilities may require unlocking through subscription or purchase. In an embodiment with through-material illumination, when the system is in the first configuration, light transmitted from the light source is not visible through the surface, and, when the system is in the second configuration, light from the light source is visible through the surface. Accordingly, the material forming the surface may be controllable to enable light passing through the surface, or to block light from passing through the surface. This may be implemented electromechanically, e.g., by operating shutters. Accordingly, the system enables locking or unlocking different physical configurations and operations of surfaces in the interior of a vehicle. This may depend on the user's subscriptions or purchases.

In addition, in an embodiment, light from the light source may be partially blocked. For example, if the second visual information represents an expanded version of the first visual information, the expansion may be made visible by adjusting the surface material in the area of the expansion (e.g., in the area where the suffix “PLUS” in the logo “SOUND SYSTEM PLUS” is to be visible), to let light from the light source pass through the material in that area.

In an embodiment, the visual information represents text and/or ambient illumination. The light from the light source can represent audio data processed at an audio system of the vehicle. For example, the light source may be used to provide mood lighting. The mood lighting may reflect the audio being played. However, these and other enhanced capabilities may be subject to the selected configuration. In particular, any such enhanced capabilities may be available only if the user unlocks the second configuration, e.g., by way of subscription or purchase.

According to another aspect, there is provided a vehicle that includes the system described above. In particular, the vehicle is an automotive vehicle. In an embodiment, the system is part of an in-vehicle infotainment system, in particular an audio system, and/or part of an in-vehicle ambient illumination system.

Thus, the system renders the vehicle adaptable and versatile. For example, a rental company or client which may not own the vehicle does not need to modify internal furniture to include permanent logos or even attach physical branding before use. No such mechanical modifications or influences are required as the present system makes it possible to switch internal appearances of the vehicle once it is turned on, based on purchases or subscriptions.

### BRIEF DESCRIPTION OF THE DRAWINGS

The features, objects, and advantages of the present disclosure will become more apparent from the detailed description set forth below when taken in conjunction with the drawings in which like reference numerals refer to the same or similar elements.

FIG. 1 schematically illustrates a system according to an embodiment of the disclosure in a first mode of operation;

FIG. 2 schematically illustrates a system according to the embodiment of FIG. 1 in a second mode of operation;

FIG. 3 illustrates operations of a system integrated in a vehicle according to an embodiment of the disclosure;

FIG. 4 illustrates a cockpit area of a vehicle that includes a system according to an embodiment of the disclosure in a first mode of operation;

FIG. 5 illustrates a cockpit area of a vehicle that includes a system according to an embodiment of the disclosure in a second mode of operation;

FIG. 6 illustrates a cockpit area of a vehicle that includes a system according to an embodiment of the disclosure in a third mode of operation;

FIG. 7 illustrates a headrest of a car seat in a vehicle that includes a system according to an embodiment of the disclosure in a first mode of operation;

FIG. 8 illustrates a headrest of a car seat in a vehicle that includes a system according to an embodiment of the disclosure in a second mode of operation;

FIG. 9 illustrates a headrest of a car seat in a vehicle that includes a system according to an embodiment of the disclosure in a third mode of operation;

FIG. 10 illustrates a portion of a dashboard of a vehicle that includes a system according to an embodiment of the disclosure in a first mode of operation;

FIG. 11 illustrates a portion of a dashboard of a vehicle that includes a system according to an embodiment of the disclosure in a second mode of operation;

FIG. 12 illustrates a portion of a dashboard of a vehicle that includes a system according to an embodiment of the disclosure in a third mode of operation;

FIG. 13 illustrates a veneer for a car door panel in a vehicle that includes a system according to an embodiment of the disclosure in a first mode of operation;

FIG. 14 illustrates a veneer for a car door panel in a vehicle that includes a system according to an embodiment of the disclosure in a second mode of operation;

FIG. 15 illustrates a veneer for a car door panel in a vehicle that includes a system according to an embodiment of the disclosure in a third mode of operation;

FIG. 16 illustrates a car door panel with a veneer in a vehicle that includes a system according to an embodiment of the disclosure in a first mode of operation;

FIG. 17 illustrates a car door panel with a veneer in a vehicle that includes a system according to an embodiment of the disclosure in a second mode of operation;

FIG. 18 illustrates a car door panel with a veneer in a vehicle that includes a system according to an embodiment of the disclosure in a third mode of operation;

FIG. 19 illustrates the interieur of a car that includes a system according to an embodiment of the disclosure in a first mode of operation;

FIG. 20 illustrates the interieur of a car that includes a system according to an embodiment of the disclosure in a second mode of operation; and

FIG. 21 illustrates the interieur of a car that includes a system according to an embodiment of the disclosure in a third mode of operation.

### DESCRIPTION OF EXEMPLARY EMBODIMENTS

According to an aspect of the present disclosure, there is provided a system for displaying visual information in a vehicle. The system comprises a light source and a controller to control the light source to display at least first and second visual information in or through a surface in the vehicle. When the system is in a first state or configuration, the controller is operable to display the first visual information only. When the system is in a second state or configuration, the controller is operable to display the second visual information. The first and second visual information may represent different scopes of services or capabilities selected by a user, e.g., by way of purchase or subscription.

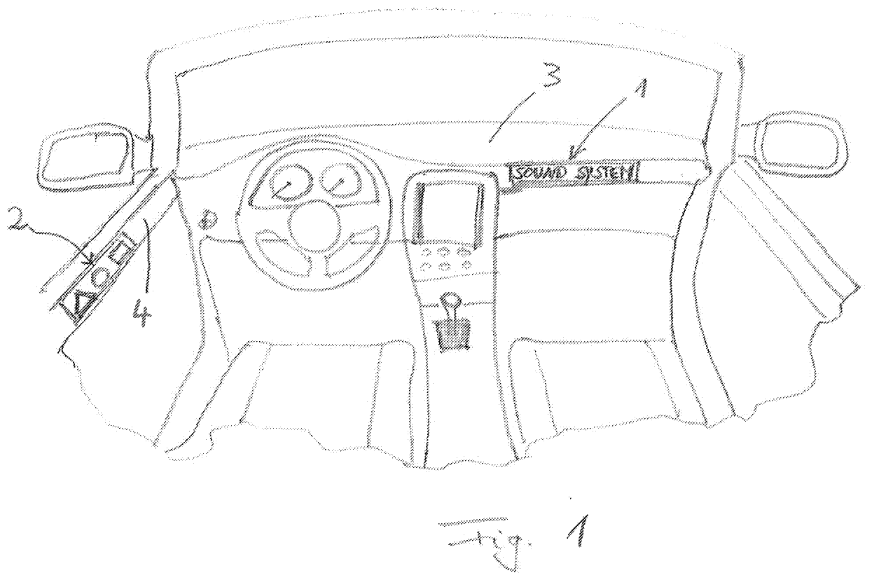

FIG. 1 illustrates a cockpit of a car in which a system according to an embodiment of the present disclosure is integrated. In the illustrated example, the system provides visual information 1 and 2 on a dashboard 3 and on a panel 4 of the driver's door, respectively. The visual information 1 is represented by the exemplary name “SOUND SYSTEM”. The visual information 2 is represented by three exemplary symbols. These representations are exemplary only and chosen for simplicity.

The visual information 1 and 2 can be displayed by projecting light from light sources (not shown) onto the corresponding surfaces of the dashboard 3 and the panel 4, respectively. Alternatively, the visual information 1 and 2 can be displayed by way of back illumination in the dashboard 3 and the panel 4, respectively.

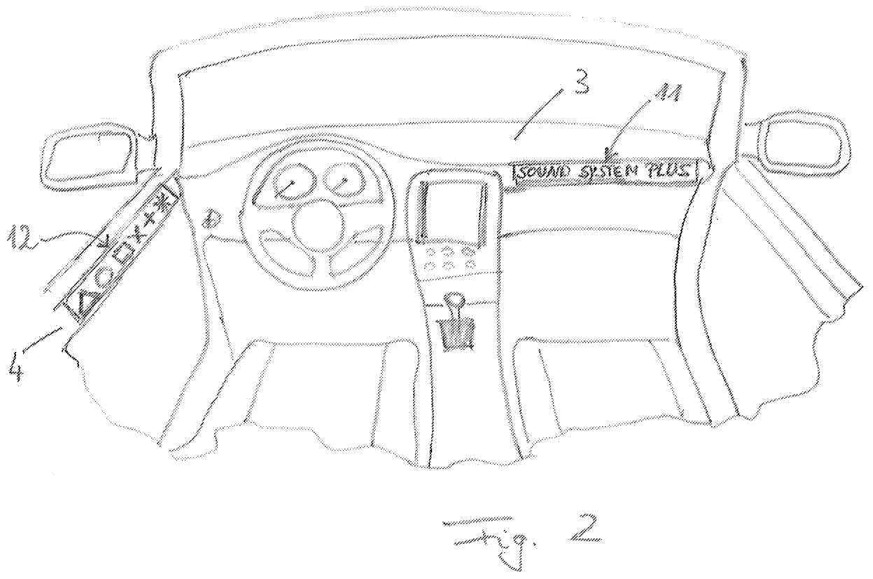

FIG. 2 shows the cockpit of FIG. 1 when different, expanded visual information 10 and 11 is displayed on the dashboard 3 and the panel 4, respectively. The expanded visual information 10 and 11 is represented by a suffix in the logo on the dashboard 3 and additional symbols on the panel 4. Again, these representations are exemplary only and chosen for simplicity.

The expanded visual information 10 and 11 corresponds to an enhanced configuration of the system. The enhanced configuration can be unlocked by way of subscription or purchase. The enhanced configuration can encompass different (expanded) visual information only. However, in embodiments of the present disclosure, the enhanced configuration also encompasses an expansion of functions of in-vehicle systems, e.g., an in-vehicle audio system.

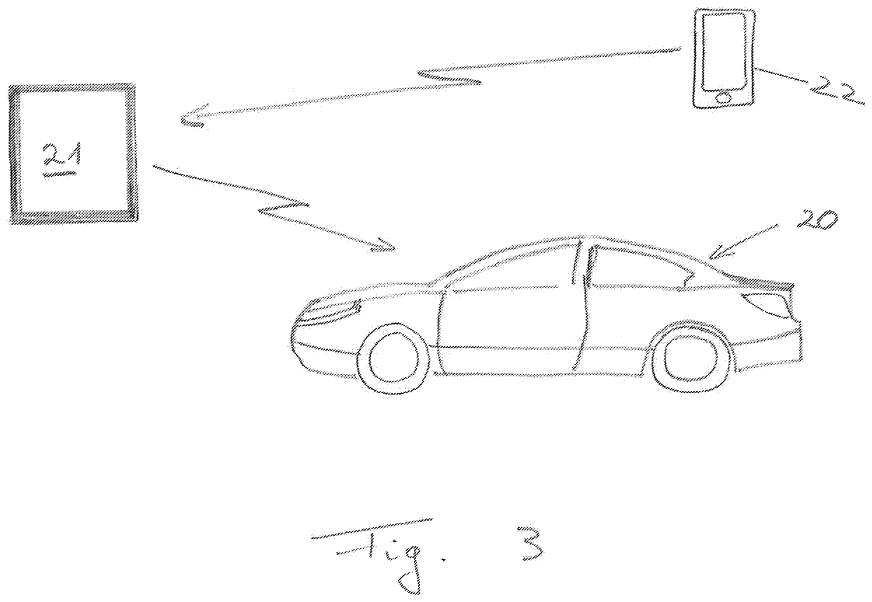

FIG. 3 illustrates an operation of the system in accordance with an embodiment of the present disclosure. In this example, the system is integrated in a vehicle 20. The vehicle 20 is communicatively coupled to a remote server 21. The remote server 21 may be operated by the manufacturer of the vehicle 20. The remote server 21 stores information related to the operation of the vehicle 20. In particular, the remote server 21 stores information on purchases and subscriptions by the user, owner or operator of the vehicle 20. Depending on the purchases and subscriptions, the system is in a basic configuration or an enhanced configuration. There may be any number of enhanced configurations, each associated with different functions and services. The vehicle 20 is configured to be capable of performing any of these functions or services. However, only selected ones of the functions or services are enabled or unlocked and made available to the user, depending on the purchases and subscriptions.

FIG. 3 also illustrates a mobile phone 22 of a user of the vehicle 20. The mobile phone 22 can be used to access the server 21 in order to make a new purchase or subscription. In response to such new purchase or subscription, the server 21 transmits a control signal to the vehicle 20. In response to receipt of the control signal from the server 21, the system changes to a new configuration. For example, the user may have changed from a standard subscription to an enhanced subscription which is associated with additional functions and services. In particular, the additional functions and services may involve enhanced audio playback, e.g., including 3D sound. The additional functions and services may be represented by a different, expanded logo, such as “SOUND SYSTEM PLUS” instead of “SOUND SYSTEM” for the basic subscription. Accordingly, in response to receipt of the control signal from the server 21, the system adjusts the display of visual information. In particular, system may adjust the display of visual information from the example shown in FIG. 1 to the example shown in FIG. 2.

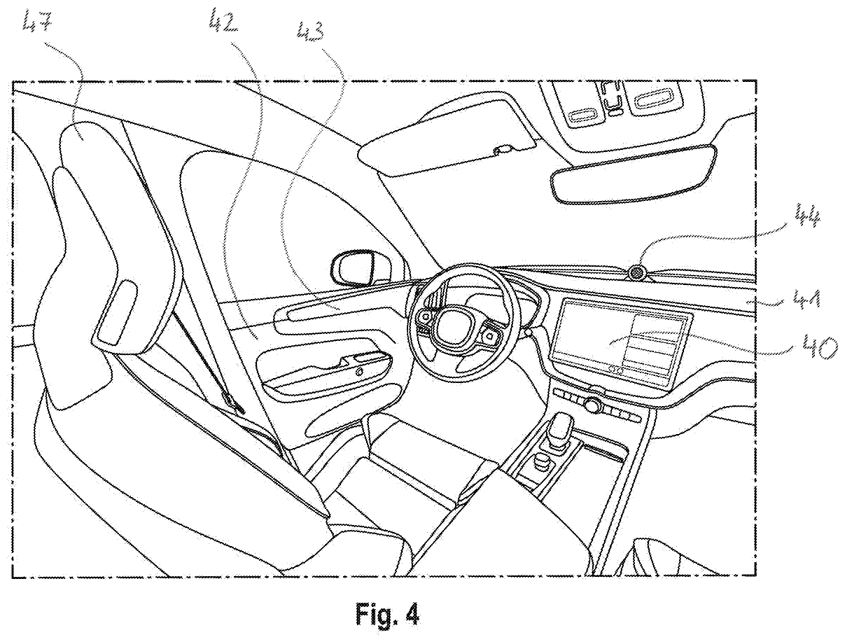

FIGS. 4 to 6 illustrate a cockpit area of a vehicle that includes a system according to an embodiment of the present disclosure. The vehicle includes a central screen 40 that is part of an infotainment system and configured to display information to a user. The screen 40 also provides a user interface. The user interface enables the user to change the settings of the system of the present disclosure. The vehicle further includes a dashboard 41, a door panel 42 of a vehicle door, and a decorative veneer 43 in the door panel 42.

FIG. 4 illustrates the cockpit area when the system is in a first mode of operation. The first mode of operation corresponds to an idle mode in which components of the system are inactive. For example, in an embodiment in which the system includes an in-vehicle audio system, the audio system is in quiet mode, and the loudspeakers of the in-vehicle audio system are not illuminated.

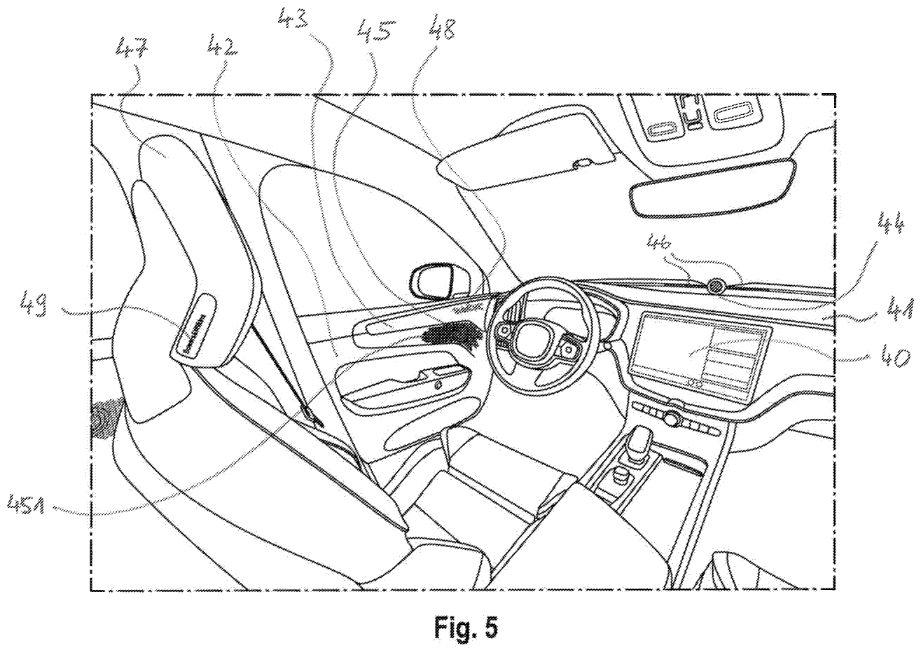

FIG. 5 illustrates the cockpit area when the system is in a second mode of operation. In the second mode of operation, the system is active. For example, in an embodiment wherein the system includes an in-vehicle audio system, the audio system may play music through the loudspeakers of the system. In FIG. 5, two of the loudspeakers of the system are visible, namely a dashboard loudspeaker 44 and a door panel loudspeaker 45. The dashboard loudspeaker 44 is arranged in the centre and top of the dashboard 41. Strip lights 46 are arranged on both sides of the dashboard loudspeaker 44. In the illustrated second mode of operation, the strip lights 46 are illuminated and indicate that the dashboard loudspeaker 44 is active. The strip lights 46 can be implemented in different configurations. For example, the strip lights 46 can extend partially or entirely across the length between the A-pillars of the vehicle. This implementation is exemplary only, and other configurations and light sources are envisaged within the scope of the present disclosure.

The door panel loudspeaker 45 is arranged underneath a meshed cover in the door panel 42 of the vehicle. In the second mode of operation illustrated in FIG. 5, the door panel loudspeaker 45 is illuminated. That is, a light source arranged underneath the meshed loudspeaker cover is activated to illuminate the area of and around the door panel loudspeaker 45 (illuminated area 451). The illumination may be such that the light intensity fades in a direction away from the dashboard, thereby providing an illumination effect that may supplement decorative elements in the door panel, such as the veneer 43. The veneer 43 also includes an illuminated area 48 corresponding to a logo or other information. The illuminated area 48 may be provided by background illumination, or by projecting the logo or other information onto the veneer 43. The displayed information may be of any type, content and design.

In addition, the system includes a second illuminated area 49 in a headrest 47 of a car seat of the vehicle. The illuminated area 49 may also be provided by background illumination, or by projecting a logo or other information onto the headrest 47. The displayed information may be identical to the information displayed in the illuminated area 48. For example, the illuminated areas 48 and 49 may display a logo or name of the maker of the loudspeakers (e.g., Bowers & Wilkins).

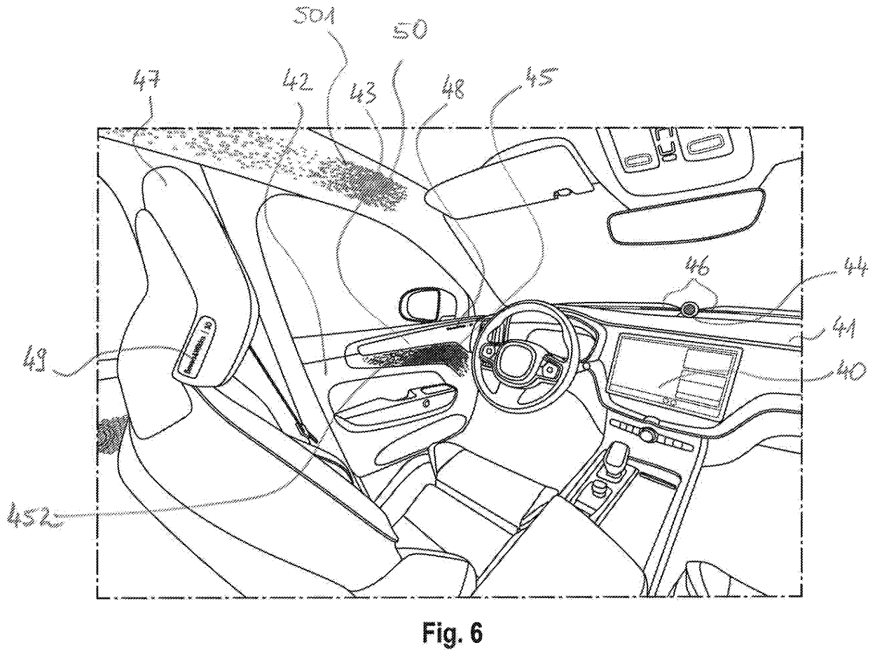

FIG. 6 illustrates the cockpit area when the system is in a third mode of operation. The third mode of operation may correspond to an enhanced mode of operation in which additional functions are activated, for example enhanced functions of the in-vehicle audio system. The enhanced mode of operation may be activated by completing an order or subscription via the user interface (central screen) 40, for example. In the illustrated example of FIG. 6, the displayed information in the illuminated areas 48, 49 is expanded to indicate an enhanced audio function, e.g., “3D”, corresponding to enhanced (3D) audio playback. In addition, the illumination of the loudspeaker 45 may be expanded to cover a larger area (illuminated area 452), and to create additional visual effects that may better supplement decorative elements in the door panel such as the veneer 43. For example, the shape of the illuminated area around the loudspeaker may match that of an adjacent decorative element such as the veneer 43.

In addition, a selection of enhanced services or functions, by way of subscription, purchase or otherwise, may cause additional loudspeakers or other elements to be activated. In the illustrated example of FIG. 6, a loudspeaker 50 in the ceiling is activated. Similar to the loudspeaker 45 in the door panel, the loudspeaker 50 may be arranged underneath a meshed cover and include or be associated with an illumination (illuminated area 511). Without the illumination of the loudspeaker 50, which only becomes operable when the enhanced mode of operation is selected, the loudspeaker remains hidden and invisible to a user. Thus, the present disclosure enables making available technical capabilities to provide enhanced services and functions in any car, unnoticeable for a user, and activating them (and making them visible) only in response to a selection of those enhanced services and functions, which may be subject to a purchase or subscription. This has the technical benefit of facilitating the production of vehicles incorporating such systems, by not having to adapt the production process to take into account a user-selected specification. This benefit, and the prospect of further revenue due to additional purchases or subscriptions, may outweigh the added cost of providing additional hardware and software regardless of user specification.

The additional and expanded visual effects in the second mode of operation illustrated in FIG. 6 are exemplary only. Further visual effects may be provided. For example, the light strips 46 may also be expanded, or illuminated in different colours. Any of the light sources may be controlled to change in accordance with audio being played back. Further, the menus that are made available to the user on the central screen 40 may be adapted to enable controlling the enhanced services and functions, e.g., by selecting an illumination intensity, colour, shape, pattern or other illumination parameters.

Further, in an embodiment, a selection of enhanced functions and services may cause a sequence of visual and/or acoustic effects to be generated. For example, the illumination sources that become available in the third mode of operation may be activated sequentially or in parallel. The illumination sources may be controlled to provide the appearance of an animation, e.g., by changing colours, shapes, patterns or other illumination parameters over a short period of time. Such visual presentation sequence may be supplemented by an audio playback to provide a stimulating acoustic experience. After completing such presentation sequence, the illumination sources may be controlled in accordance with a normal operation in the third mode.

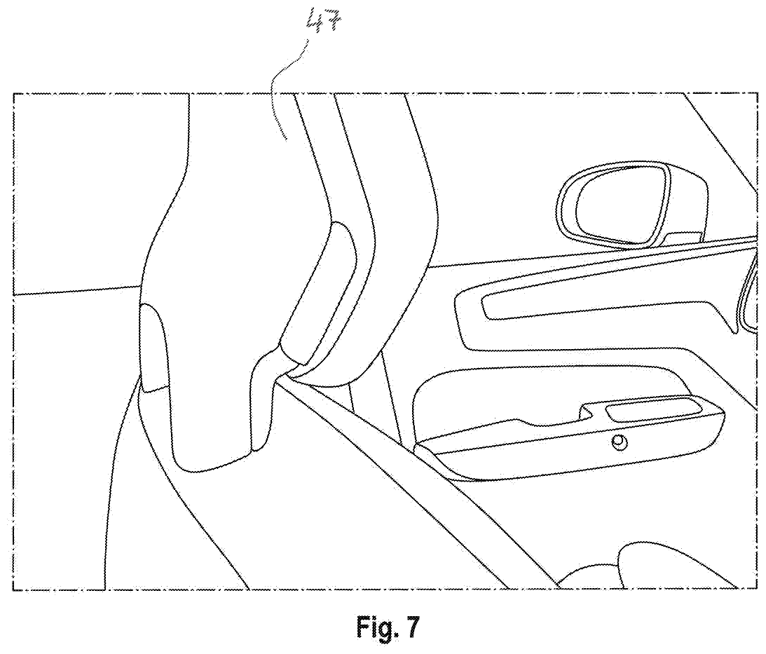

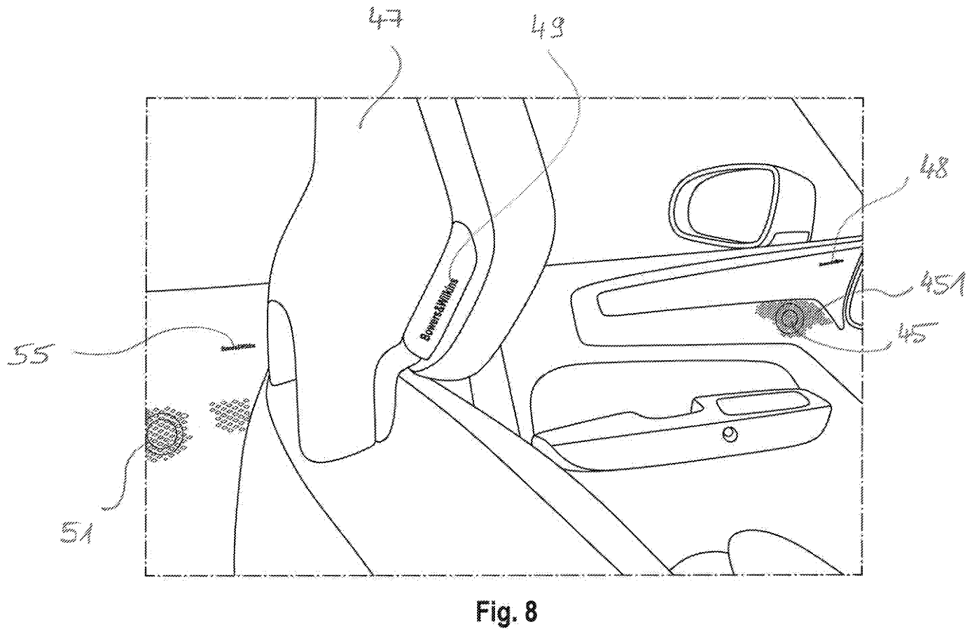

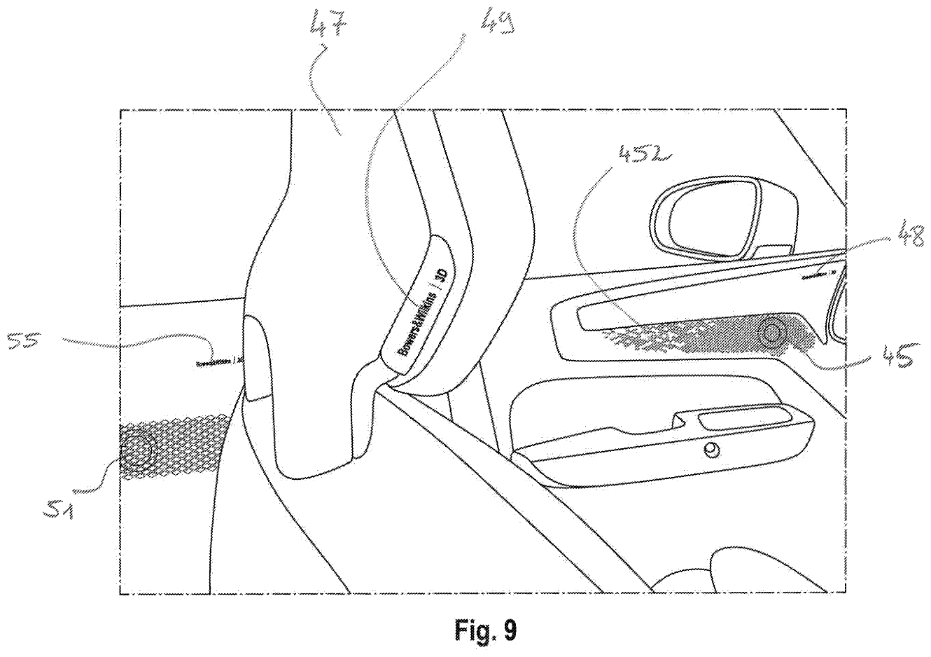

FIGS. 7 to 9 illustrate a headrest 47 of a car seat in a vehicle that includes a system according to an embodiment of the disclosure in the first, second and third modes of operations, respectively. In the first mode of operation (FIG. 7), the system is idle. In the second mode of operation (FIG. 8), the system is active and operable to provide a default set of services and functions. Accordingly, the illuminated area 49 displays a logo or information that corresponds to the default set of services and functions. In the illustrated example, the make of the audio system is displayed (Bowers & Wilkins). In the third mode of operation (FIG. 9), the illuminated area 49 includes additional information to indicate that enhanced services and functions are available and active. In the illustrated example, the displayed name is expanded with a suffix that indicates a scope of the enhanced functions (e.g., 3D audio playback).

In FIGS. 7 to 9, the illuminated area 49 is arranged at a side of the headrest. The information is displayed in a substantially vertical direction. This is exemplary only. The illuminated area 49 may be arranged at other locations of the headrest 47 or the car seat. Also, there may be more than one illuminated area at the headrest or car seat. Further, the illuminated area 49 may include light strips or other illumination device to provide desired visual effects. The displayed information may be controlled to be dynamic, e.g., to change in accordance with audio being played back, or in accordance with other parameters such as background light, a detected number of passengers in the car, or the like.

In FIGS. 8 and 9, an additional loudspeaker 51 and an additional illuminated area 55 (logo) is visible in the back of the vehicle. These additional features are described in more detail below.

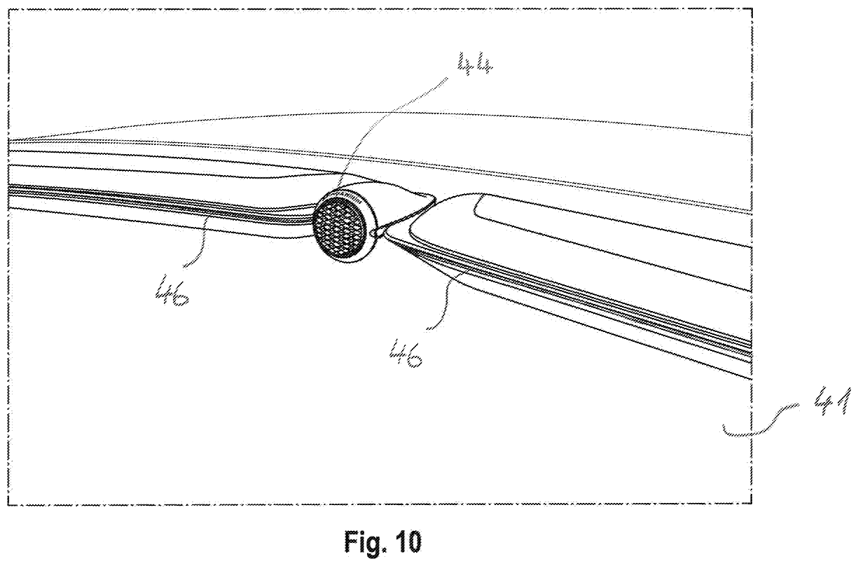

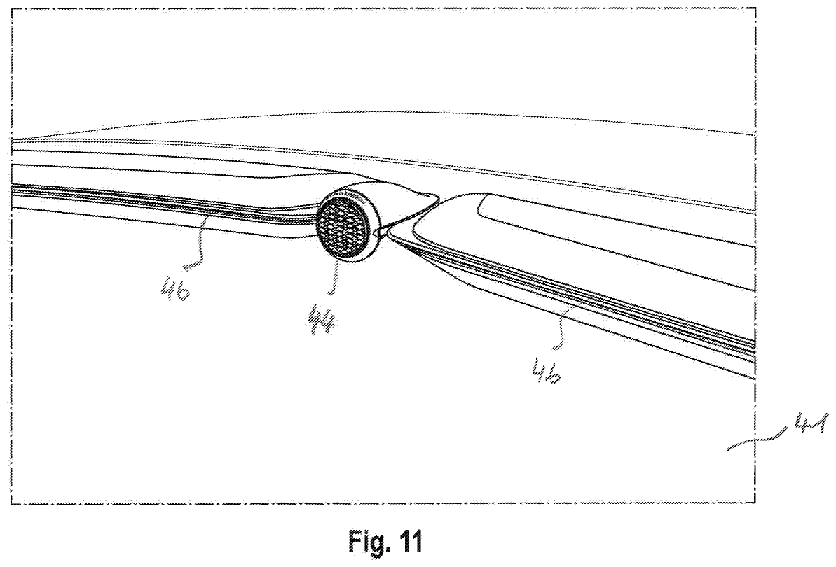

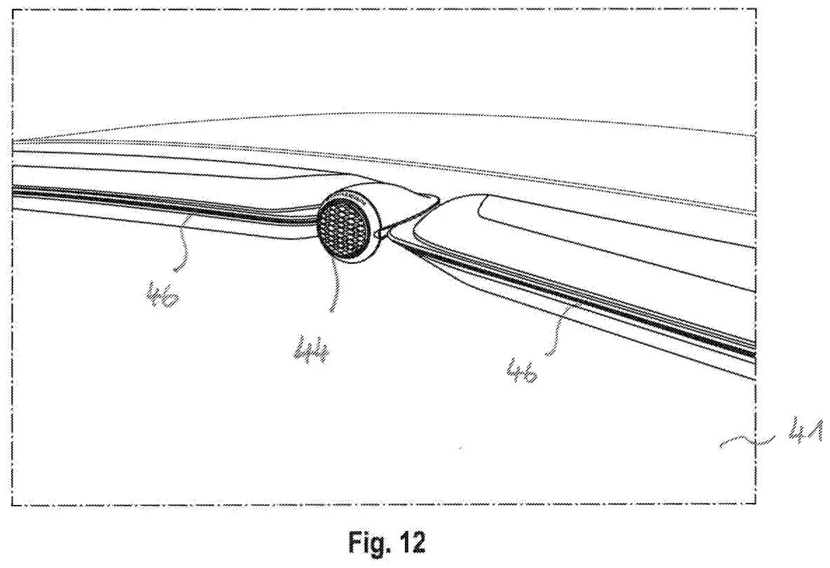

FIGS. 10 to 12 illustrate a portion of the dashboard 41 according to an embodiment of the disclosure in the first, second and third modes of operations, respectively. In the first mode of operation (FIG. 10), the system is idle. In the first mode of operations, the light strips 46 adjacent to the centre loudspeaker 44 are not illuminated. In the second mode of operation (FIG. 11), the system is active and operable to provide a default set of services and functions. In this mode, the light strips 46 emit light. In the illustrated example, the light strips 46 emit white light. In the third mode of operation (FIG. 12), the light strips 46 are controlled to emit light in a different colour, e.g., red light. In the third mode, the light strips 46 may also be controllable by a user to emit light in a selected colour. Also, the light strips 46 may be controllable to emit light in changing colours, or in accordance with audio being played back. Accordingly, in the third mode, the enhanced services and functions may also include functions relating to the illumination of the light strips 46.

In FIGS. 10 to 12, the light strips 46 are arranged at both sides of and extending away from the loudspeaker 44. This arrangement is exemplary only. There may be additional light strips, or the light strips may be arranged in a different manner, e.g., around the housing of the loudspeaker 44. Also, there may be light sources other than light strips, in addition to or instead of the illustrated light strips 46. For example, there may be light sources to provide background illumination underneath one of the surfaces of the dashboard 41. Also, logos or other information may be projected onto the surface of the dashboard 41. These are examples, and the present disclosure is not limited in this regard.

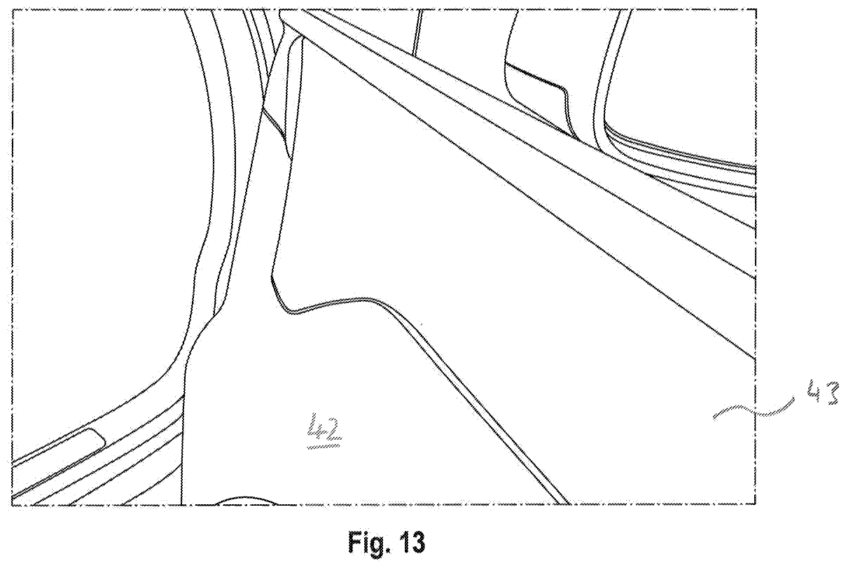

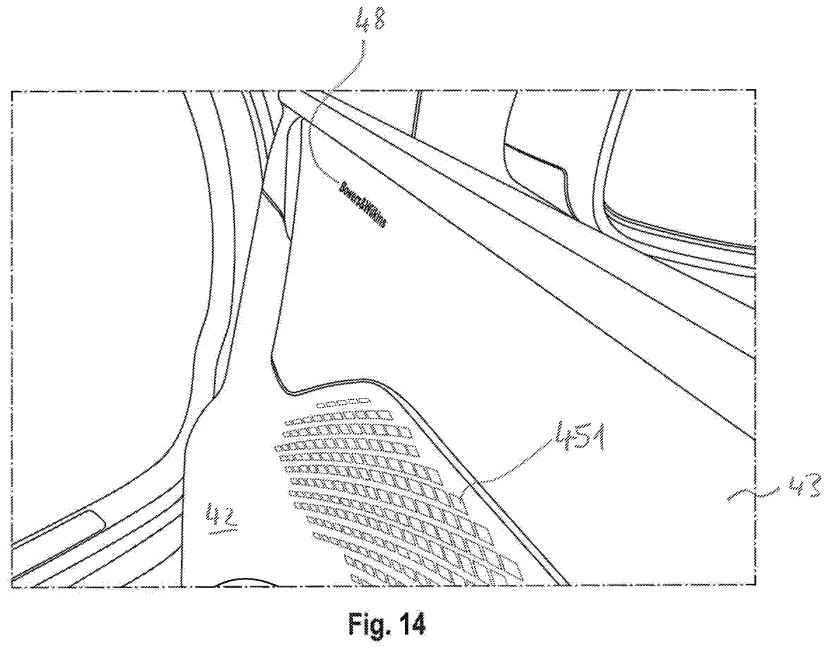

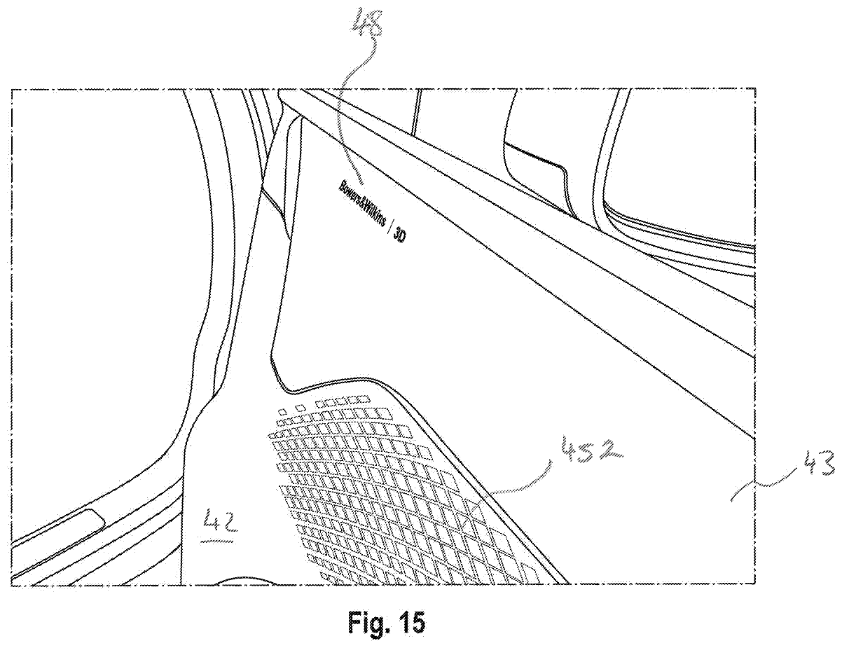

FIGS. 13 to 15 is a closer illustration of the veneer 43 in the car door panel 42 in a vehicle that includes a system according to an embodiment of the disclosure in the first, second and third modes of operations, respectively. In the first mode of operation (FIG. 13), the system is idle. In the second mode of operation (FIG. 14), the system is active and operable to provide a default set of services and functions. In this mode, the illuminated area 48 includes a logo or information that corresponds to the default set of services and functions. In the illustrated example, the make of the audio system is displayed (Bowers & Wilkins). In the third mode of operation (FIG. 15), additional information is displayed to indicate that enhanced services and functions are available and active. In the illustrated example, the displayed name is expanded with a suffix that indicates a scope of the enhanced functions (e.g., 3D audio playback).

In FIGS. 13 to 15, the illuminated area 48 is arranged near the top end of the wooden veneer 43, which is arranged in the door panel 42 of a passenger door. The information is displayed in a substantially horizontal direction. This is exemplary only. The illuminated area 48 may be arranged at other locations of the veneer 43 or door panel 42. Also, there may be more than one illuminated area at the veneer 43 or door panel. Further, the illuminated area 48 may include light strips, e.g., at the edges of the veneer 43, or other illumination device to provide desired visual effects. The displayed information may be controlled to be dynamic, e.g., to change in accordance with audio being played back, or in accordance with other parameters such as background light, detected passengers, or the like. The present disclosure is not limited in this regard.

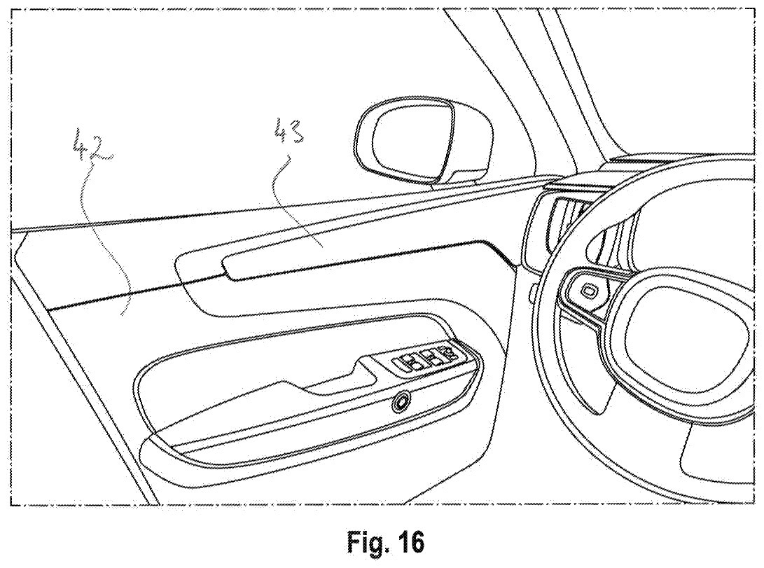

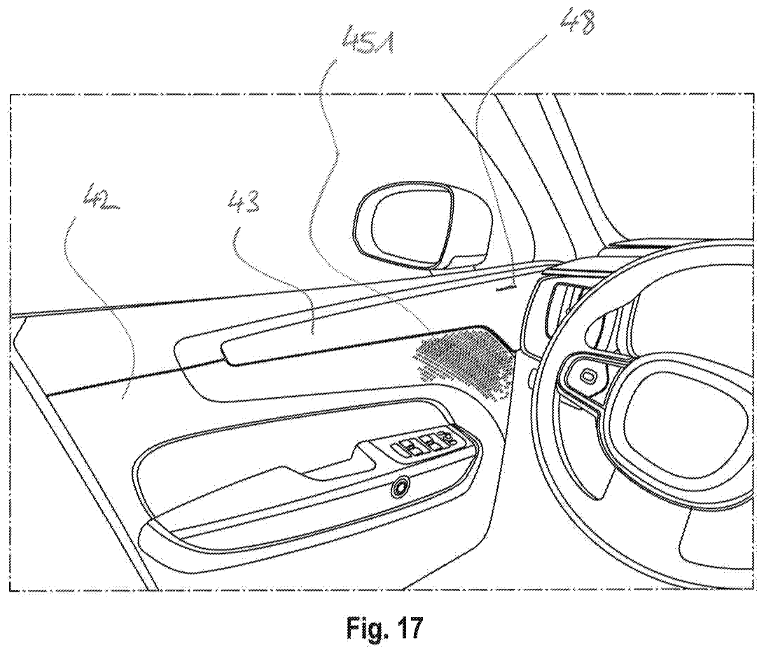

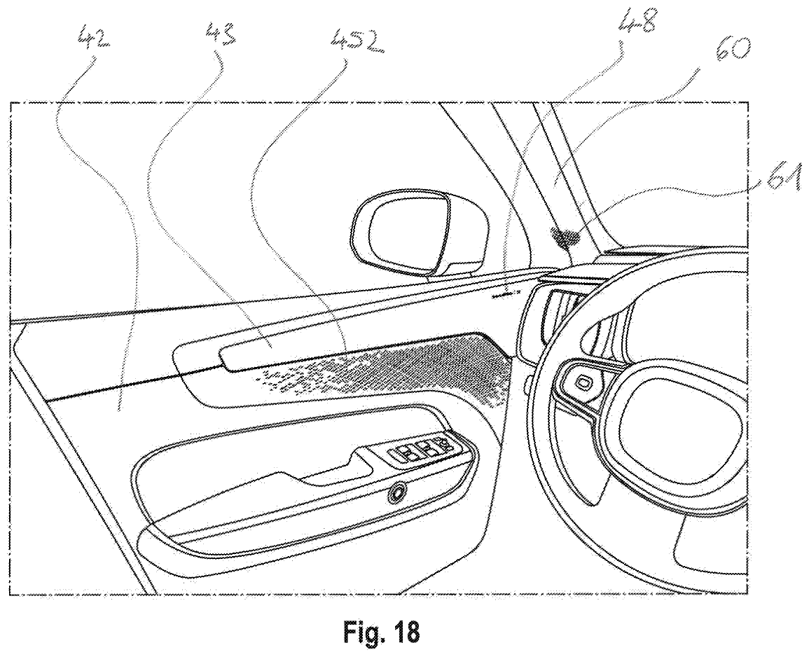

FIGS. 16 to 18 is an illustration of the door panel 42 on the driver side of a vehicle including a system according to an embodiment of the present disclosure in the first, second and third modes of operations, respectively. Similar to FIGS. 13 to 15, in the first mode of operation (FIG. 16), the system is idle. In the second mode of operation (FIG. 17), the system is active and operable to provide a default set of services and functions. In the third mode of operation (FIG. 18), additional information is displayed to indicate that enhanced services and functions are available and active. In the illustrated example, the displayed name is expanded with a suffix that indicates a scope of the enhanced functions (3D audio playback).

FIGS. 17 and 18 also illustrate the illuminated areas 451 and 452, respectively. In the third mode of operation, the illuminated area 452 is expanded relative to the illuminated area 451 of the second mode of operation. As illustrated in FIG. 18, an additional illuminated area 60 may be arranged in the A-pillar 61. The illuminated area 60 may be part of an additional loudspeaker in the A-pillar which becomes available and active only the third mode of operation.

FIGS. 16 to 18 illustrate an exemplary embodiment. The veneer 43 and illuminated area 48 may be modified as described in connection with FIGS. 13 to 15. Other modifications are also possible.

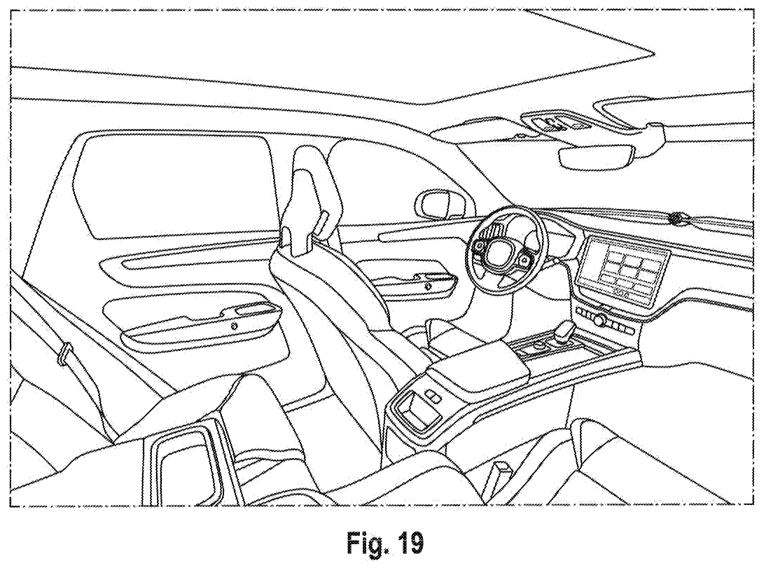

FIGS. 19 to 21 illustrate the interieur of a car that includes a system according to an embodiment of the disclosure in the first, second and third modes of operations. FIGS. 19 to 21 include the cockpit area as already described in connection with FIGS. 4 to 6. In addition, FIGS. 19 to 21 illustrate a part of a rear passenger compartment.

FIG. 19 illustrates the car interior when the system is in the first mode of operation in which the components of the system are inactive. For example, in an embodiment in which the system includes an in-vehicle audio system, the audio system is in quiet mode, and the loudspeakers of the in-vehicle audio system are not illuminated.

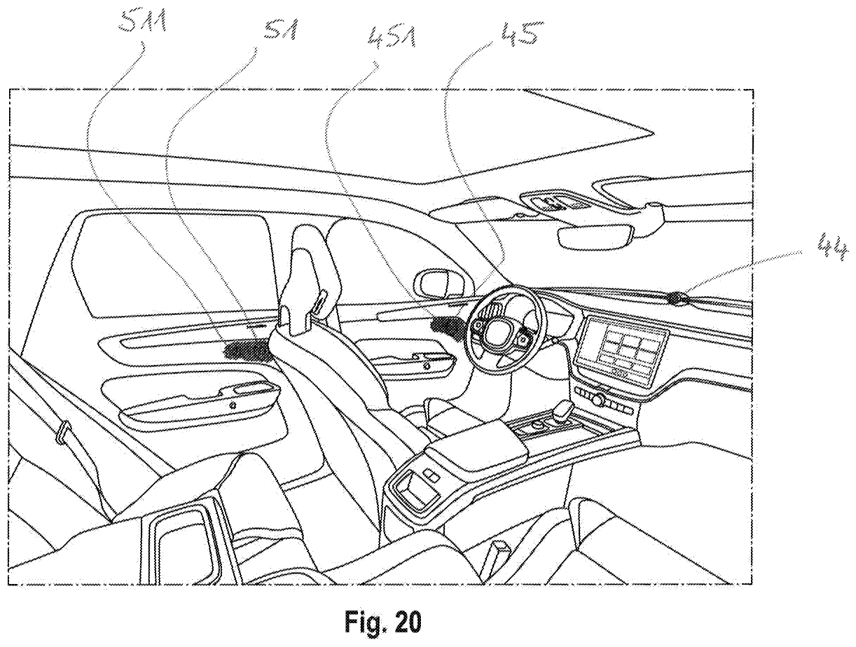

FIG. 20 illustrates the car interior when the system is in the second mode of operation in which the system is active. For example, in an embodiment wherein the system includes an in-vehicle audio system, the audio system may play music through the loudspeakers of the system. In addition to the loudspeakers 44 and 45 in the cockpit area, a loudspeaker 51 is arranged in a door panel of the left rear door. Similar to the loudspeaker 45, the loudspeaker 51 is arranged underneath a meshed cover in the door panel and may have a light source arranged underneath the meshed loudspeaker cover. In the second mode of operation, the light source is activated to illuminate the area of and around the loudspeaker 51 (illuminated area 511). The illuminated area 511 in the back may be similar to the illuminated area 451 in the front, thereby to provide a visually consistent appearance in the front and back of the car interior.

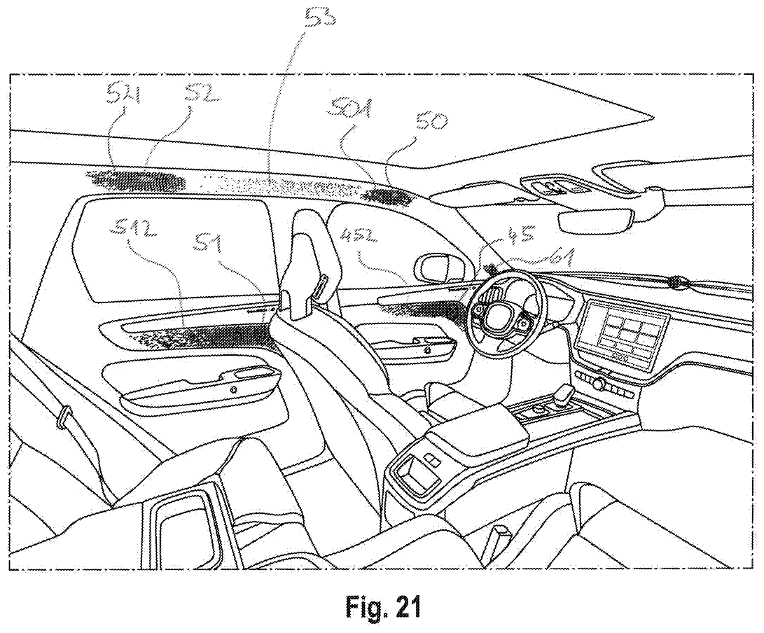

FIG. 21 illustrates the car interior when the system is in the third mode of operation in which additional functions are activated, for example enhanced functions of the in-vehicle audio system. In the illustrated example, the illumination of the loudspeaker 51 is expanded to cover a larger area (illuminated area 512), similar to the expanded illuminated area 452 in the front. In particular, the shape of the expanded illuminated area 512 may match or be similar to the illuminated area 452 in the front.

In addition, as part of the enhanced services or functions in the third more of operation, an additional loudspeaker 52 in the ceiling above the left rear door is activated. There may also be a corresponding loudspeaker in the ceiling above the right rear door, which is not visible in illustration of FIG. 21. Similar to the ceiling loudspeaker 50 in the front, the ceiling loudspeaker 52 in the back may be arranged underneath a meshed cover and include an illumination (illuminated area 521). In the second mode of operation, without illumination, loudspeaker 52 is invisible to the passengers, as illustrated in FIG. 20. In the third mode of operation, as illustrated in FIG. 21, with the illumination activated, the loudspeaker 52 becomes visible.

The illuminated areas 501 and 521 may extend along the entire length of the ceiling, from an A-column to a C-column of the car. In an embodiment, there is a meshed cover that covers both loudspeakers 50 and 52. The meshed cover may be configured to provide various visual effects. For example, the meshed cover may be configured to allow more light from a light source to pass through in the vicinity of the loudspeakers 50 and 52 than in an area 53 between the loudspeakers 50 and 52. In another embodiment, visual effects may be provided based on the arrangement and operation of one or more light sources behind the meshed cover. For example, the arrangement of the light sources may be such as to provide a brighter or denser light pattern in the vicinity of the loudspeakers 50 and 52, and to provide a more subdued illumination in the area 53 between the loudspeakers 50 and 52.

The visual effects and light patterns illustrated and described in connection with FIG. 21 are exemplary only. Further visual effects may be provided. For example, the illumination of the ceiling loudspeakers 50 and 52 may be controlled to change in accordance with audio being played back. Further, the illumination of the ceiling loudspeakers 50 and 52 may be part of a presentation sequence, wherein, for example, the front ceiling loudspeaker 50 (and its counterpart on the passenger side) are illuminated first, followed by an illumination of the area 53 between the ceiling loudspeakers 50 and 52, followed by an illumination of the rear ceiling loudspeaker 52 (and its counterpart on the right side of the rear passenger compartment). Additional visual and acoustic effects relating to the rear ceiling loudspeakers may be implemented, analogous to the effects described above in connection with the loudspeaker 50.

In some of the described embodiments, there are three modes of operations, corresponding to an idle mode, a default mode of operation, and an enhanced mode of operation, respectively. The described number and scope of the modes, operations and functions are exemplary only. For example, there may be different enhanced modes of operation, each corresponding to a different set of configurations and services. Each enhanced mode may be subject to a different subscription or purchase by a user.

In another embodiment, any of the illuminations or illuminated areas may include panels having a plurality of pixels that may be controlled individually. In other words, the illumination can be turned on pixel by pixel. The panels and pixels may be controlled differently depending on the mode in which the system is operated. For example, in the first mode, some or all of the pixels of a panel may be inactive. In the second mode, a portion of the pixels may be illuminated. In the third mode, additional pixels may be activated, thereby to provide larger illuminated areas, and/or illuminated areas with a higher resolution or density. The panels may also include lenses for controlling the direction, distribution and density of emitted light.

For completeness, it is noted that the Figures illustrate only sections of a vehicle that includes a system according to embodiments of the present disclosure. It is to be understood that the illustrated features may also be present in other, non-illustrated sections of the vehicle. For example, FIG. 18 illustrates an additional illuminated area 61 in the A-pillar on the driver side of the vehicle. A corresponding illuminated area may also be arranged in the A-pillar on the passenger side. This may apply to all other illustrated and described features analogously. In other words, all illustrated and described features may be “symmetrically” arranged on both (driver and passenger) sides of the vehicle.

The description of embodiments and aspects has been presented merely for purposes of illustration and explanation. Suitable modifications and variations to the embodiments and aspects may be performed in light of the above, and different embodiments and aspects may be combined where possible and appropriate, without departing from the scope of protection as determined by the claims.

1. An in-vehicle system comprising:
one or more loudspeakers;
one or more illumination devices associated with the one or more loudspeakers; and
a controller to control at least one of the one or more illumination devices and the one or more loudspeakers,
wherein the at least one of the one or more illumination devices and the one or more loudspeakers are controllable to provide a set of functions,
wherein the controller is configured to operate in at least a first mode of operation and a second mode of operation,
wherein in the first mode of operation, the controller is configured to control the at least one of the one or more illumination devices and the one or more loudspeakers to provide only a subset of the set of functions, and
wherein in the second mode of operation, the controller is further configured to control the at least one of the one or more illumination devices and the one or more loudspeakers to provide an entirety of the set of functions.

2. The system of claim 1, wherein the controller is further configured to switch from the first mode of operation to the second mode of operation in response to receiving a control signal from a remote server.

3. The system of claim 2, further comprising a user interface to enable a user to input a command to cause the remote server to generate and transmit the control signal.

4. The system of claim 1:
wherein the controller is further configured to control the one or more illumination devices to display at least first visual information and second visual information in or through a surface in a vehicle, and
wherein, when the controller is in the first mode of operation, the controller is operable to display the first visual information only, and, when the controller is in the second mode of operation, the controller is operable to display the second visual information.

5. The system of claim 1, wherein the system is included in or coupled to at least one of an in-vehicle audio system, and an in-vehicle illumination system.

6. The system of claim 1, wherein the system is included in or coupled to an in-vehicle audio system, and wherein, in response to receipt of a control signal, the system is configured to alter at least one of one or more parameters and a configuration of an in-vehicle audio system.

7. The system of claim 1, wherein, in response to receipt of a control signal, the system is configured to alter at least one of one or more parameters and a configuration of a user interface.

8. The system of claim 4, wherein at least one of the controller is configured to display one of the first visual information or the second visual information at least temporarily in response to activating the system, wherein the first visual information is included in the second visual information, and wherein the second visual information represents an altered or expanded version of the first visual information.

9. The system of claim 1, wherein the one or more illumination devices comprise at least one of a light emitting diode (LED), an array of LEDs, and an array of individually controllable LEDs.

10. The system of claim 1 further comprising at least one first processor to at least one of process, store, or generate visual data, and at least one mapping processor to map the visual data to input signals which cause the one or more illumination devices to generate the first visual information or the second visual information.

11. The system of claim 1, further comprising a component for a vehicle, the component being configured to be integrated in a dashboard, loudspeaker, pillar, roof, door, seat, ceiling or floor of the vehicle, wherein the one or more illumination devices and a surface of the vehicle are incorporated into the component.

12. The system of claim 11, wherein the surface is configured for through-material illumination, wherein, when the controller is in the first mode of operation, light transmitted from at least one of the one or more illumination devices is not visible through at least part of the surface of the component, and when the controller is in the second mode of operation, light from all illumination devices is visible through the surface.

13. The system of claim 11, at least one of wherein the surface comprises one or more of a flexible material, a fabric material, a porous material, an acrylic material, and a wooden material, and wherein the surface comprises one of a pattern, and a pattern formed by holes in the surface.

14. The system of claim 4, wherein the first visual information or the second visual information represents at least one of text and ambient illumination, and wherein light from the one or more illumination devices represents audio data processed at an audio system of the vehicle.

15. A vehicle comprising the system of claim 1, wherein the vehicle is an automotive vehicle, and wherein the system is part of an in-vehicle infotainment system including at least one of, an audio system, or an in-vehicle ambient illumination system.

16. An in-vehicle system comprising:
one or more loudspeakers;
one or more illumination devices; and
a controller programmed to control at least one of the one or more illumination devices and the one or more loudspeakers,
wherein the at least one of the one or more illumination devices and the one or more loudspeakers are controllable to provide a set of functions,
wherein the controller is further programmed to operate in at least a first mode of operation and a second mode of operation,
wherein in the first mode of operation, the controller is programmed to control at least one of the one or more illumination devices and the one or more loudspeakers to provide only a subset of the set of functions, and
wherein in the second mode of operation, the controller is further programmed to control the one or more illumination devices and the one or more loudspeakers to provide an entirety of the set of functions.

17. The system of claim 16, wherein the controller is further programmed to switch from the first mode of operation to the second mode of operation in response to receiving a control signal from a remote server.

18. The system of claim 17 further comprising a user interface to enable a user to input a command to cause the remote server to generate and transmit the control signal.

19. The system of claim 16:
wherein the controller is further programmed to control the one or more illumination devices to display at least first visual information and second visual information in or through a surface in a vehicle, and
wherein, when the controller is in the first mode of operation, the controller is operable to display the first visual information only, and, when the controller is in the second mode of operation, the controller is operable to display the second visual information.

20. An in-vehicle system comprising:
one or more loudspeakers;
one or more illumination devices; and
a controller programmed to control the one or more illumination devices and the one or more loudspeakers,
wherein the at least one of the one or more illumination devices and the one or more loudspeakers are controllable to provide a set of functions,
wherein the controller is further programmed to operate in at least a first mode of operation and a second mode of operation,
wherein in the first mode of operation, the controller is programmed to control at least one of the one or more illumination devices and the one or more loudspeakers to provide only a subset of the set of functions, and
wherein in the second mode of operation, the controller is further programmed to control the one or more illumination devices and the one or more loudspeakers to provide an entirety of the set of functions.
